(19) United States
(12) Patent Application Publication
(10) Pub. No.: US 2021/0388867 A1
(43) Pub. Date: Dec. 16, 2021

(54) ANGULAR CONTACT BEARING WITH LASER ETCHED OUTER RING

(71) Applicant: Schaeffler Technologies AG & Co. KG, Herzogenaurach (DE)

(72) Inventor: Igor Cardozo Mendes Ribeiro, Sterling Heights, MI (US)

(73) Assignee: Schaeffler Technologies AG & Co. KG, Herzogenaurach (US)

(21) Appl. No.: 16/902,302

(22) Filed: Jun. 16, 2020

(51) Int. Cl. F16C 19/36; F16C 43/06

(52) U.S. Cl. CPC F16C 19/361; F16C 2220/60; F16C 43/06

(57) ABSTRACT

A bearing includes an inner ring, an outer ring, and a plurality of rollers. The rollers separate the inner ring from the outer ring. The outer ring has an outer radial surface with a circumferentially continuous portion and a plurality of axial projections extending from the circumferentially continuous portion. To improve the security of the press fit connection between outer ring and a housing, surfaces of the outer ring which contact the housing are treated with a laser etching process. The laser etching may be applied to the circumferentially continuous portion and/or to the outer surface of the axial projections. The laser etching process removes a small amount of material from the surface, creating valleys. The removed material is clumped on its surroundings, building peaks. The peaks and valleys increase the friction between the outer ring and the housing, reducing the chance of failures.

### TECHNICAL FIELD

This disclosure pertains to the technical area of bearings. More particularly, it pertains to the area of angular contact ball bearings.

### BACKGROUND

Bearing are used to reduce parasitic drag between components that are intended to have relative rotation. Radial bearings transfer forces between components transverse to the axis of relative rotation. Axial bearings transfer axial forces between components. Certain types of bearings, such as angular contact ball bearings and tapered roller bearings transfer both axial and radial forces.

### SUMMARY

A bearing includes an inner ring, an outer ring, and a plurality of rollers. The rollers separate the inner ring from the outer ring. The outer ring has an outer radial surface with a circumferentially continuous portion and a plurality of axial projections extending from the circumferentially continuous portion. The outer surface has a laser etched finish. The bearing may be an angular contact ball bearing with lines of contact canted away from the circumferentially continuous portion. The outer ring may be press fit into a housing. The axial projections may axially contact an abutment of the housing. The outer ring may have a conical outer surface between the axial projections.

An outer bearing ring a circumferentially continuous outer radial surface, a plurality of axial projections extending from the circumferentially continuous portion, and a conical outer surface between the axial projections. An outer surface of the axial projections has a laser etched finish. The circumferentially continuous outer radial surface may also have a laser etched finish. The outer bearing ring may have an inner surface defining a raceway, wherein the raceway is configured for angular contact with ball rollers. A line of action of the rollers may be canted away from the circumferentially continuous portion.

A method of making a bearing includes fabricating an outer ring with an outer radial surface and then laser etching the outer surface. The outer radial surface has a circumferentially continuous portion and a plurality of axial projections extending from the circumferentially continuous portion. A plurality of balls may be inserted into a cage and placed in angular contact with an outer race formed into an inner surface of the outer ring. The balls may also be placed in contact with an inner race formed into an outer surface of an inner ring. The outer ring may be press fit into a housing.

### BRIEF DESCRIPTION OF THE DRAWINGS

FIG. 1 is a cross-sectional view of an angular contact ball bearing.

FIG. 2 is a pictorial view of an outer ring of the bearing of FIG. 1.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

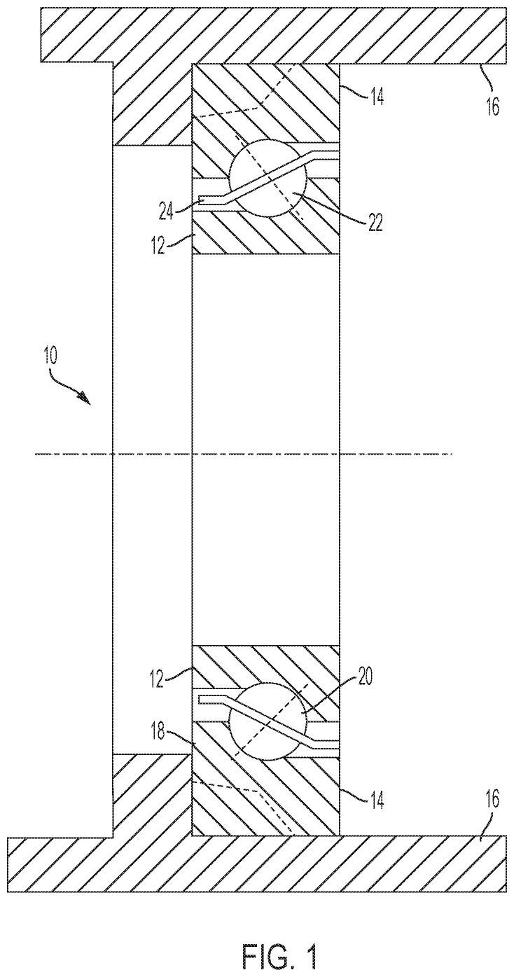

FIG. 1 is a cross section of an angular contact ball bearing 10. Many features, but not all, are axisymmetric about a centerline. The bearing includes an inner ring 12 adapted for fixation to a rotatable shaft (not shown) and an outer ring 14 adapted for fixation to a housing 16. A radially inner surface of the outer ring 14 defines an outer race 18. Similarly, a radially outer surface of the inner ring 12 defines an inner race 20. A set of balls 22 rolls in the inner and outer races. The balls 22 are separated from one another circumferentially by a cage 24.

FIG. 1 illustrates an angular contact ball bearing. The outer race 18 is offset to the left of the inner race 20. Forces between the balls and the races occur along a line of action illustrated by the dotted line. The line of action is not perpendicular to the centerline but is instead canted toward the left. An angular contact bearing transmits both axial forces and radial forces between the inner ring 12 and the outer ring 14, and thus between the shaft and the housing 16.

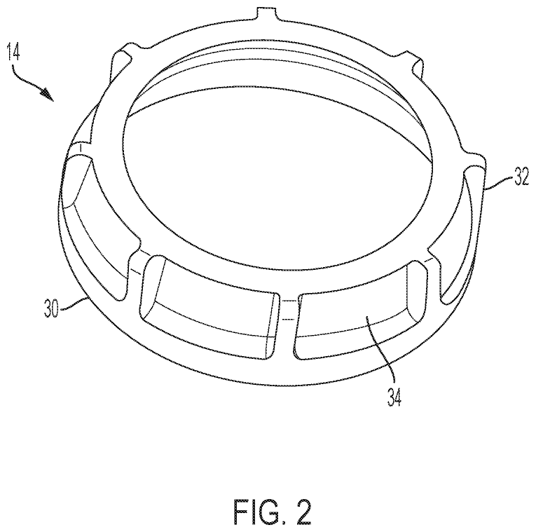

FIG. 2 is a pictorial view of the outer ring 14. The outer shape is designed to remove significant mass relative to a simple rectangular shape. On one end of the ring, a portion 30 of the outer surface runs circumferentially continuously around the outer ring. A number of projections 32 extend axially from the circumferentially continuous portion to the opposite end of the outer ring. Between axial projections, the outer surfaces includes one or more conical sections 34.

The outer ring 14 is fixed to housing 16 using a press fit. A secure connection between the outer ring and the housing is important to durability of the assembly. If the outer ring slips with respect to the housing, that can cause tilting or distortion of the outer race with respect to the inner race. The reduction of mass has the detrimental side effect of reducing the contact area with the housing, making the press fit less secure.

To improve the security of the press fit connection between outer ring 14 and housing 16, surfaces of outer ring 14 which contact the housing are treated with a laser etching process. The laser etching may be applied to the circumferentially continuous portion and/or to the outer surface of the axial projections. The laser etching process removes a small amount of material from the surface, creating valleys. The removed material is clumped on its surroundings, building peaks. The peaks and valleys increase the friction between the outer ring and the housing. This reduces the chance of failures and improves bearing and system lifetime.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A bearing comprising:
an inner ring;
an outer ring; and
a plurality of rollers separating the inner ring from the outer ring; wherein:
the outer ring has an outer radial surface with a circumferentially continuous portion and a plurality of axial projections extending from the circumferentially continuous portion, the outer surface having a laser etched finish.

2. The bearing of claim 1 wherein the bearing is an angular contact ball bearing with lines of contact canted away from the circumferentially continuous portion.

3. The bearing of claim 1 wherein the outer ring is press fit into a housing.

4. The bearing of claim 3 wherein the axial projections axially contact an abutment of the housing.

5. The bearing of claim 1 wherein the outer ring has a conical outer surface between the axial projections.

6. An outer bearing ring comprising:
a circumferentially continuous outer radial surface;
a plurality of axial projections extending from the circumferentially continuous portion, an outer surface of the axial projections having a laser etched finish; and
a conical outer surface between the axial projections.

7. The outer bearing ring of claim 6 wherein the circumferentially continuous outer radial surface also has a laser etched finish.

8. The outer bearing ring of claim 6 having an inner surface defining a raceway, wherein the raceway is configured for angular contact with ball rollers.

9. The outer bearing ring of claim 8 wherein a line of action of the rollers is canted away from the circumferentially continuous portion.

10. A method of making a bearing, the method comprising:
fabricating an outer ring, the outer ring having has an outer radial surface with a circumferentially continuous portion and a plurality of axial projections extending from the circumferentially continuous portion; and
laser etching the outer surface.

11. The method of claim 10 further comprising inserting a plurality of balls into a cage and placing the balls in contact with an outer race formed into an inner surface of the outer ring.

12. The method of claim 11 wherein the balls are placed in angular contact with the outer race.

13. The method of claim 11 further comprising placing the balls in contact with an inner race formed into an outer surface of an inner ring.

14. The method of claim 13 further comprising press fitting the outer ring into a housing.
